(19) United States
(12) Patent Application Publication
(10) Pub. No.: US 2011/0239482 A1
(43) Pub. Date: Oct. 6, 2011

(54) Process for the cleaning of rolls, brushes and similar items, and dry-cleaning device for effecting this process

(75) Inventor: Giuseppe Rosa, Montorso VIC. VICENZA (IT)

(73) Assignee: Rosauto S.r.l., Montebello VIC. VICENZA (IT)

(21) Appl. No.: 12/932,623

(22) Filed: Mar. 1, 2011

(30) Foreign Application Priority Data
Mar. 12, 2010 (IT) MI2010A000398
Sep. 28, 2010 (IT) MI2010A001766

(51) Int. Cl. F26B 17/30

(52) U.S. Cl. 34/397; 34/58

(57) ABSTRACT

A device for the dry-cleaning of rolls and brushes, which comprises a rotating support (1, 8) for the rotation of a roll (4) and a brush (10) respectively. In this way, the cleaning of rolls, brushes and similar items is substantially effected without the formation of polluting waste-products to be disposed of. According to the invention, on the contrary, all the colour extracted from the brushes is recovered for its re-use, for example as a first coating colour for subsequent paintings. A pump (35) is also envisaged for the recovery and recirculation of water collected in the upper part of the container and sprayed onto the roll (4) and/or brush (10) to be cleaned.

The present invention relates to an improved process for the cleaning of rolls, brushes and similar items. The invention is also extended to the device used for effecting this process.

The field of the invention is that relating to systems used for cleaning rolls, brushes and other similar items, normally used for colouring internal walls of buildings with colours and water-paints in general.

It has been demonstrated that, at the end of each working day, or when a colour shade must be changed, the operator must efficiently wash the roll or brush with the use of considerable quantities of non-returnable water. For this purpose, small washing machines for rolls and brushes are currently available in which pressurized jets of water are used for washing the dirty coloured bristles. These machines, however, have the disadvantage of filling up with water and colour right from the first washings, generating considerable quantities of wastewater to be disposed of.

The known art of cleaning brushes, rolls and similar items described above by washing with water consequently creates inevitable and serious problems relating to the disposal of the wastewater and the environmental impact of the same. Even if the water is simply dirtied by mural water-paints, it is still polluted by the latter and consequently cannot be discharged into the sewers and even less so dispersed indiscriminately in the atmosphere.

Furthermore, the disposal of washing wastewater does not allow the colour extracted to be recovered from the bristles of the rolls and brushes and consequently the overall painting of walls requires greater quantities of colour and higher costs than those strictly necessary for effecting painting operations.

The main objective of the present invention is therefore to provide an improved process, and the device for effecting it, which are particularly effective for cleaning rolls, brushes and similar items, said process not creating the traditional formation of polluting wastewater to be disposed of.

A further objective of the invention is to provide a process and device of the type specified above, which allow the colour extracted from the rolls and brushes to be recovered.

Another objective of the invention is to provide a device which allows the rolls and brushes to be cleaned also in environments where the pressurized water of the central water supply system is not available.

These and other objectives are achieved with the process and device of the independent claims enclosed. The preferred embodiments of the invention are specified in the remaining claims.

With respect to the known art, the invention offers the advantage of allowing the cleaning of rolls, brushes and similar items substantially without the formation of polluting wastewater to be disposed of. According to the invention, on the contrary, all the colour extracted from the brushes and rolls is recovered for its re-use, for example as a first coating colour for subsequent paintings. The process and device of the invention also allow the rolls and brushes to be cleaned in a different container for each shade.

These and other objectives, advantages and characteristics are evident from the following description of some preferred embodiments of the process and device of the present invention illustrated, for non-limiting purposes, in the figures of the enclosed drawings. In these:

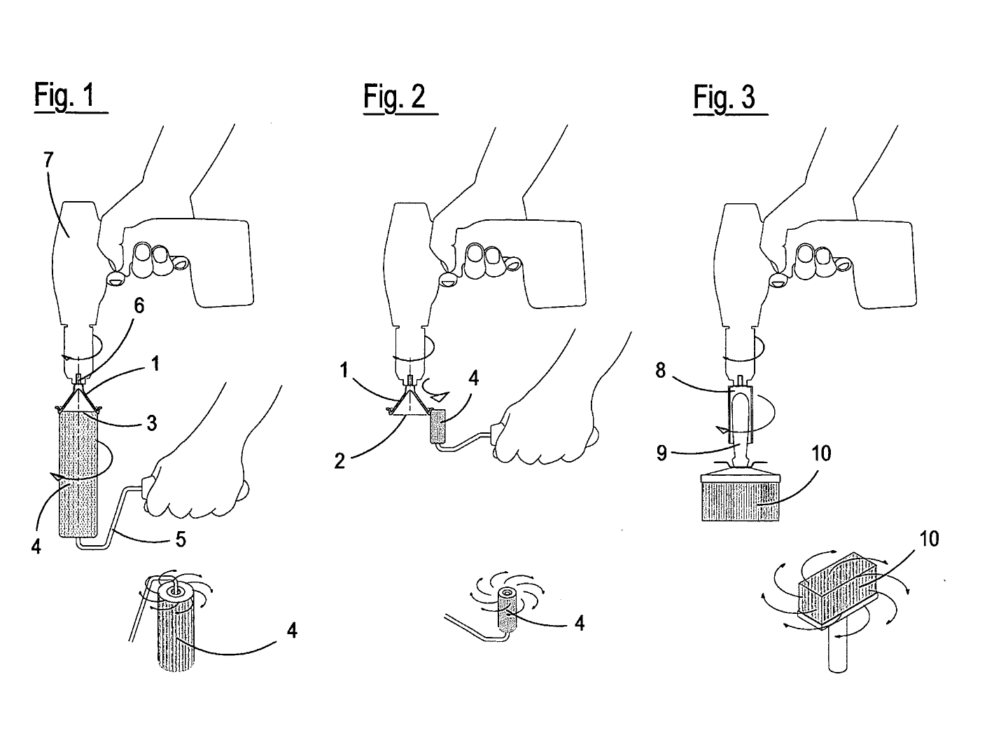

FIGS. 1 to 3 illustrate a first example of the cleaning device of rolls and brushes according to the invention;

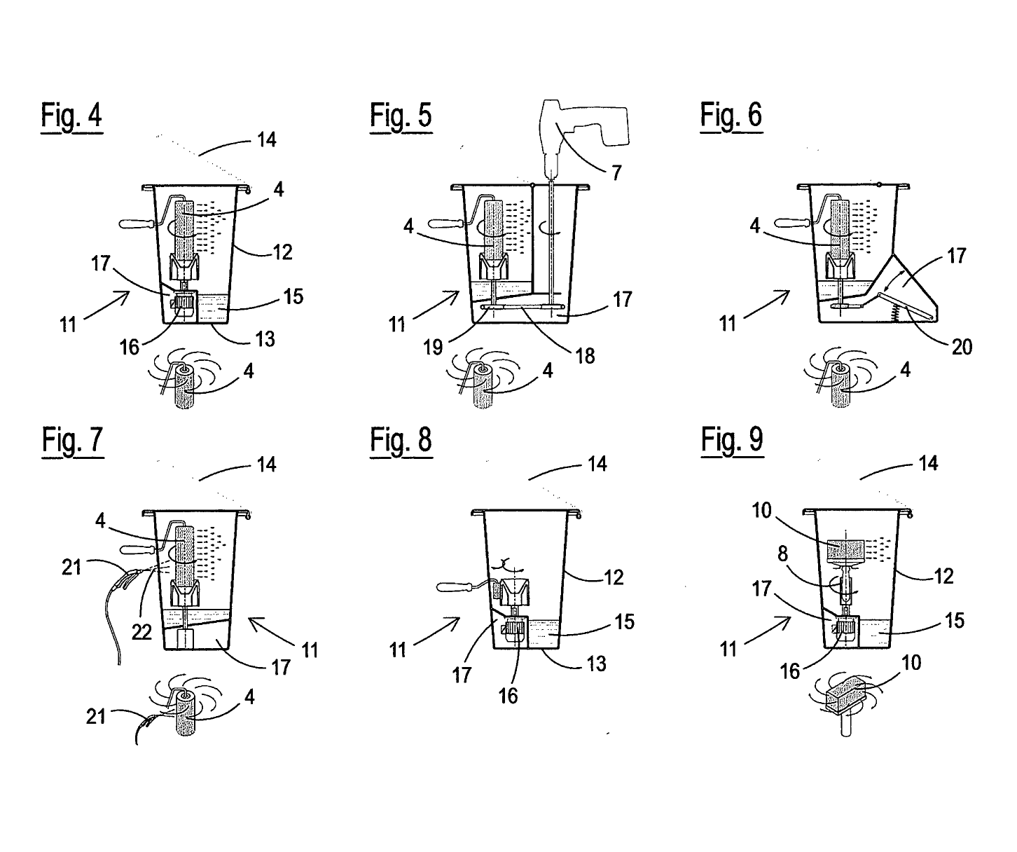

FIGS. 4 to 8 illustrate further embodiments of the cleaning device of rolls according to the invention;

FIG. 9 illustrate a further embodiment of the cleaning device of brushes according to the invention;

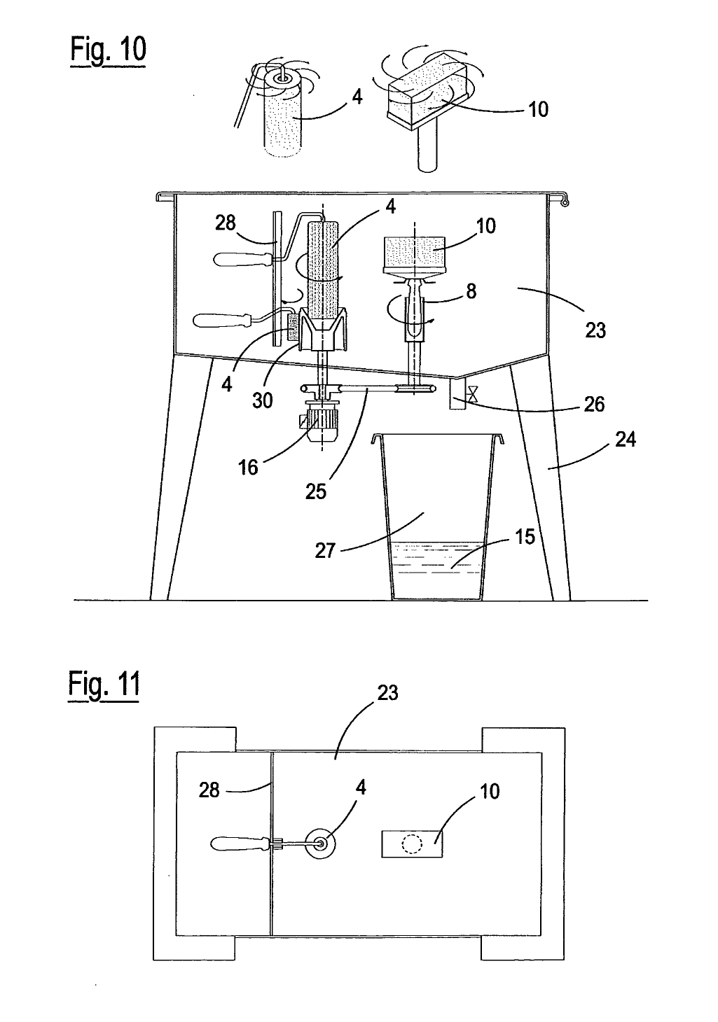

FIGS. 10 and 11 illustrate a universal example of a device for the cleaning of both rolls and brushes, in a side and plan view respectively;

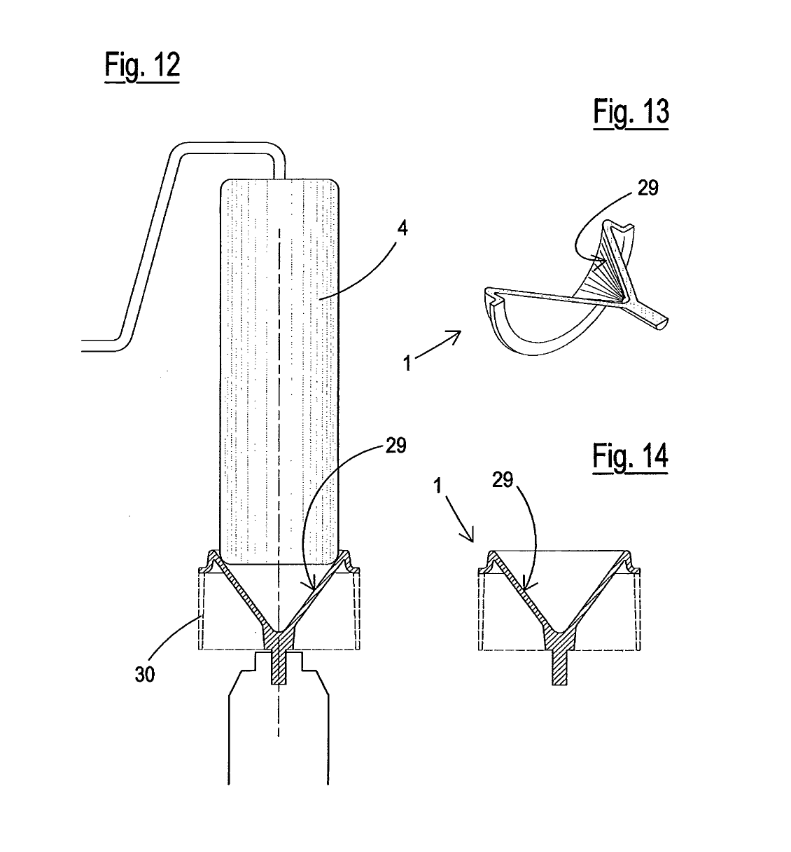

FIGS. 12 to 14 illustrate further details of the device of the previous figures;

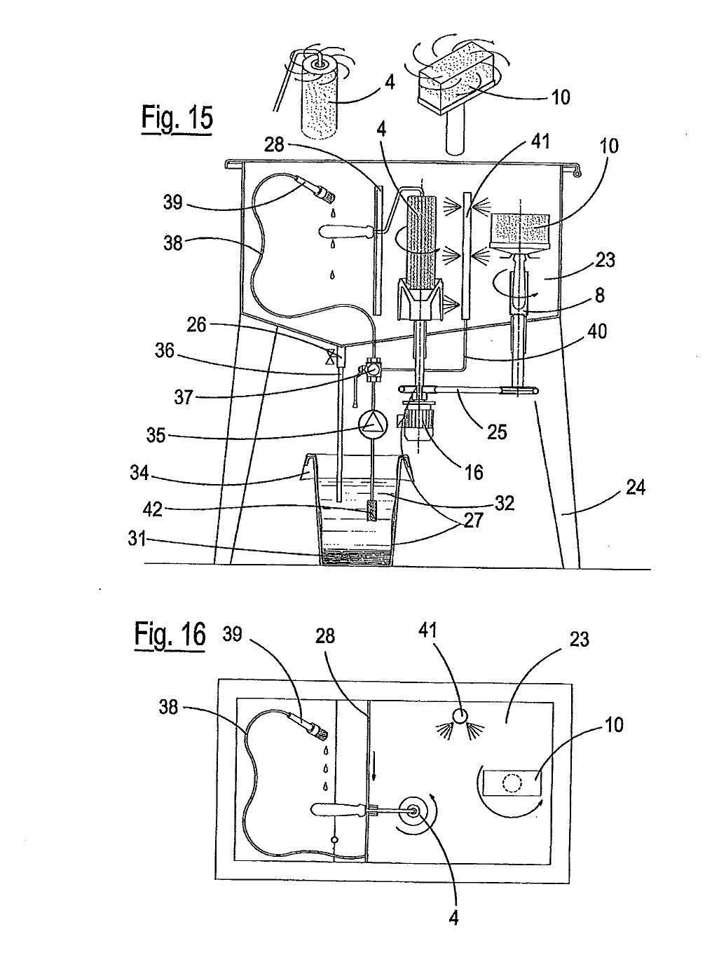

FIGS. 15 and 16 illustrate a further universal example of a device for the cleaning of both rolls and brushes, in a side and plan view respectively.

The device of the invention, as illustrated in the example of FIG. 1, consists of an axial-symmetrical rotating support 1, advantageously cone- or funnel-shaped. The same support 1, preferably but not necessarily, is externally cylindrically or almost cylindrically shaped, with a substantially “M”-shaped longitudinal section which defines an internal conical housing 29 and a substantially cylindrical outer wall 30, as illustrated in FIGS. 12 to 14.

In particular, the above support 1, in correspondence with its larger base 2, is engaged on the end 3 of the roll 4, opposite to that carrying the handle 5. On its opposite base, on the other hand, the cone 1 has an attachment element 6 to the system for its rotation, in the example, an electric screwer (7).

The cone-shaped structure of the rotating support 1 has the advantage of offering an internal seat 29, suitable for receiving and rotating the rolls 4 having a different diameter. The outer wall 30 having a cylindrical or almost cylindrical form of the rotating support 1, in turn, has the advantage of offering a flat surface, suitable for the attachment and rotation of the smaller rolls, also thanks to the presence of grooves or gripping notches on the surfaces.

With the equipment described hereunder, it is possible to effect the dry-cleaning of the roll 4, by rotating it at a sufficient velocity to cause the colour to be removed or detached from the bristles of the roll or brush. In this way, in fact, due to the centrifugal action exerted on the colour adhering to the bristles of the roll, this is substantially separated in the dry state, i.e. with the contribution of the mechanical action alone and without the help of jets of water. In a few seconds of centrifugation of the roll 4, an almost perfect cleaning of the same is obtained and the operator can rapidly re-use the same rolls for applying a different colour.

In order to obtain an even better cleaning, it is sufficient to wet the roll 4 with clean water, after effecting the first centrifugation, and repeating a second centrifugation for a few seconds. In this way, an almost dry roll is obtained, which consequently does not create problems of dripping.

For the dry-cleaning of rolls having a small diameter, a higher rotation rate is necessary. The smaller the roll, in fact, the higher the rotation rate at which it must be subjected for its cleaning, must be. For this purpose, as better illustrated in FIG. 2, the roll 4 is rotated by resting it on the outer edge of the cone 1 on the larger side of its base 2, or on the outer cylindrical wall 30. In this way, the rotation rate of the roll 4 is considerably increased: the smaller the diameter of the roll, in fact, the more revs are effected per minute, all the other conditions remaining unaltered.

In the embodiment of the device of the invention illustrated in FIG. 3, the rotating support is substantially in the form of a mandrel or cylindrical body 8, suitable for receiving and holding the handle 9 of a brush 10.

In the variant of FIGS. 4 to 9, the roll 4 and brush 10 are housed inside a container 11, having a wall 12 which surrounds the item to be cleaned. This container is preferably, but not necessarily, closed in its lower part by a bottom 13 for recovering the colour 15 extracted, whereas a lid 14 can be opened in the upper part of the same container 11. In conformance with this variant, the device of the invention allows the recovery of the colour 15 which adheres to the bristles of the roll or brush and which, by centrifugal action, is first thrust again the wall 12 of the container and then, by gravity, falls onto the bottom 13 of the latter.

As illustrated in the examples of FIGS. 4, 8 and 9, the rotation of the roll 4 or brush 10 is promoted by an electric motor 16, situated on the bottom 13 of the container 11 and isolated, with respect to the colour extracted 15, inside a respective housing 17.

In the variant illustrated in FIG. 5, the rotation is exerted on the roll 4 by means of a drill or screwer 7 equipped with a transmission 18 to a pulley 19, the latter arranged in association with the attachment element 6 of the cone 1 to the rotatable instrument of this drill or screwer. The same solution, adapted to the structure of the mandrel 8 of the instrument of FIG. 3, can be advantageously used for the dry-cleaning of a brush 10.

In the variant illustrated in FIG. 6, the rotation exerted on the item to be cleaned (roll or brush) is ensured by a pedal mechanism 20 whereas, in that of FIG. 7, a nozzle 21 is used, which thrusts a jet of pressureized air 22 in a position tangential to the roll 4.

The device of the invention, as illustrated in figures 10 and 11, essentially has the form of a tank 23, maintained in a suspended position by means of feet 24. Both of the rotatable supports 1 and 8, respectively engaged on the roll 4 and handle 9 of the brush 10 are housed inside said tank 23, together with a bulkhead 28 for keeping the handle of the roll 4 blocked and the same separated from the centrifugal area, together with the relative transmission 25 to motor means 16. The device is completed by a tap 26 which allows the discharge, into a bucket 27, of the colour recovered on the bottom of the tank 23.

FIGS. 15 and 16 show a further perfected embodiment of the device of the present invention.

Also in this example, there is the presence of a tank 23, maintained in a suspended position by means of feet 24. Both of the rotatable supports 1 and 8, respectively engaged on the roll 4 and handle 9 of the brush 10 are housed inside said tank 23. Also in this case there is a bulkhead 28 for keeping the handle of the roll 4 blocked and the same separated from the centrifugal area, together with the relative transmission 25 to motor means 16. The device is completed by a tap 26 which, with the help of a discharge pipe 36, allows the discharge of the colour recovered, passing through the filter 42 so that the water 32 remains almost unpolluted, on the bottom of the tank 23, into a bucket or bin 27, preferably of at least 20 litres.

In this further example, various improvements are applied which make the device of the invention an actual washing machine.

There is in fact a new combination which envisages at least one pump 35 in the device, preferably electric. This pump 35 collects the water from the upper part of the bin 27 and feeds it towards a three-way valve 37. This valve 37 provides a selective feeding, on the one hand, through a pipe 38, to a brush 39 which serves for manually washing the whole equipment (sponges, spatulas, buckets, etc.) which cannot be included in the centrifuge and for washing in the difficult points. On the other hand, the valve 37 feeds water for washing the brushes 10 and the same rolls 4 through a pipe 40 connected to spray nozzles 41.

In particular, upon observing FIGS. 15 and 16, it can be seen that there is preferably a nylon bag 34 in the bin 27. Said bag 34 is initially filled with clean water or water and detergent. As the washing of the various brushes 10 and rolls 4 is effected, the water in the bin 27 becomes dirty; a part is collected by the filter 42 and after a few hours the densest and heaviest part of the water-paint diluted in the water precipitates onto the bottom of the nylon bag 34 and forms a solid deposit 31. The water 32 which is in the upper part of the bin 27 is consequently relatively clean and is suitable for the washing of the various operating instruments, used as recycled water.

The importance of the assembly of the pump 35 in this machine, which actively collaborates with the washings of the whole equipment (sponges, spatulas, buckets, etc.) which are difficult to position inside a normal centrifuge, is therefore evident. It also collaborates with washing the brushes 10 and rolls 4 themselves.

After the manual work, the brushes 10 and rolls 4 are naturally put into the centrifuge: in this way, all the dirt which is situated in the innermost parts is released and it is also important as the relatively dirty water used for the washing is also eliminated. As specified above, after this operation, by turning the three-way valve 37 on the other side, this feeds the pipe 40 and nozzles 41, which serve for the automatic washing of the brush 10 and roll 4 and also for washing the internal walls of the machine itself, which have been dirtied with water-paint.

The best solution, for the automatic washing, is to feed the nozzles 41 while the brush 10 and roll 4 are slowly rotating; the nozzles 41 subsequently stop the flow of water; the centrifuge is then started and rotates for a few seconds. In this way a dry centrifugation is effected. It is advisable to repeat this cycle various times.

The recycled water 32 is poured into another bin (not shown) and the water-paint can be coagulated and separated herein or it can be disposed of by specialized companies. The solid paint 31 remains in the first bin 27, inside the nylon bag 34, and can be easily extracted and subsequently mixed with other water-paints and reused or disposed of.

In this way, a machine has been constructed, which can efficiently wash all the equipment used for painting, exclusively or almost exclusively adopting the same recovered and recycled water.

1. A process for the cleaning of rolls, brushes and similar items, characterized in that it envisages the dry separation of the colour from the bristles of said rolls or brushes.

2. The process according to claim 1, characterized in that said separation is effected by centrifugal force, by imparting a sufficient rotation to said rolls or brushes for obtaining the detachment of the colour from their bristles.

3. The process according to claim 2, characterized in that said rotation imparted to the rolls and brushes is sufficiently high to allow centrifugation.

4. The process according to claim 1, characterized in that it envisages the recovery of the colour which adheres to the bristles of the roll or brush and which, by centrifugal action, is first thrust against the side walls of a container and then, by gravity, falls onto the bottom of the same.

5. The process according to claim 4, characterized in that, after the first dry centrifugation, said rolls and brushes are wet with water and the centrifugation is repeated a second time.

6. The process according to claim 1, characterized in that the cleaning of rolls (4) having a small diameter is effected by means of a rotating support (1) preferably, but not necessarily, having a cylindrical or almost cylindrical external form (30), the external surface of said roll (4) being maintained tangentially resting on the outer edge of the support (1) on the side of its larger base (2), or on said cylindrical surface (30) of the support (1).

7. A process for the cleaning of rolls, brushes and similar items, which envisages the dry separation of the colour from the bristles of roils, brushes or similar items (4, 10) by means of centrifugal force, by imparting a sufficient rotation to said rolls, brushes or similar items, with recovery of the colour thrust outwardly into a container (23) and which falls, by gravity, onto the bottom of the container (27), characterized in that it envisages the feeding of recycled water (32), collected in the upper part of the container (27) and separated by gravity from a solid deposit (15, 31) which falls onto the bottom, by at least one pump (35), onto said rolls, brushes or similar items (4, 10).

8. The process according to claim 7, characterized in that said feeding of said recycled water (32) is effected with the use of nozzles (41), brushes (39) and/or similar items.

9. A device for cleaning rolls, brushes and similar items, characterized in that it is equipped with suitable means for effecting the dry cleaning process, according to one or more of the previous claims.

10. The device according to claim 9, characterized in that it comprises a rotating support (1, 8) for the rotation of a roll (4) and a brush (10) respectively.

11. The device according to claim 10, characterized in that said rotating support (1) comprises a cavity with a cone-shaped inner housing (29).

12. The device according to claim 11, characterized in that it is funnel-shaped.

13. The device according to claim 11, characterized in that it has an external cylindrical shape, for example with a substantially “M”-shaped longitudinal which section delineates the mentioned inner conical housing (29) and an external wall (30) having a substantially cylindrical shape.

14. The device according to claim 9, characterized in that the larger base (2) of said conical housing (29) is suitable for being engaged on the end (3) of said roll (4), opposite to that containing its handle (5), said outer wall (30), when present, of said support (1), having the cylindrical or almost cylindrical form suitable for attaching and transmitting the rotation of the smaller rolls, the other end of the same cone (1) comprising a connecting element (6) to the rotation system of said roll.

15. The device according to claim 14, characterized in that said rotating support is in the form of a substantially cylindrical body (8) and that it has the function of a mandrel, suitable for blocking and rotating the handle (9) of said brush (10).

16. The device according to claim 9, characterized in that it also comprises a container (11) having side walls (12) suitable for receiving the jets of colour centrifuged from the mentioned rolls and brushes, as well as a bottom surface (13) for collecting said colour.

17. The device according to claim 16, characterized in that on the bottom surface (13) of said container (1) there is a housing (17) for containing said rotation systems of the rolls or brushes, said housing being isolated with respect to the colour (15) collected on the same bottom surface (13).

18. The device according to claim 9, characterized in that it also includes a tank (23) equipped with both the mentioned rotating supports (1, 8) which are engaged on the rolls (4) and the handle (9) of the brushes (10), respectively, and a bulkhead (28) for keeping the handle of the roll blocked and the same separated from the centrifugation area, said device also including the transmission (25) of the above-mentioned rotation system of the same rolls and brushes.

19. The device according to claim 9, wherein a rotating support (1, 8) is envisaged for the rotation of a roll (4) and, respectively, a brush (10), a container (27) suitable for receiving the jets of colour centrifuged by the mentioned rolls or brushes and equipped with a bottom (13) for the collection of the colour, by gravity, characterized in that it also comprises a pump (35) which collects, in the upper part of the container (27), recycled water (32) separated by gravity and by the filter (42) from a solid deposit (15, 31), which falls onto the bottom, and feeds it onto said rolls, brushes or similar items (4,10).

20. The device according to claim 19, characterized in that it also envisages nozzles (41), brushes (39) and/or similar items connected to said at least one pump (35), for the feeding of said recycled water (32) onto bristles of rolls, brushes or similar items (4, 10) to be cleaned.
